(19) United States
(12) Patent Application Publication
(10) Pub. No.: US 2005/0243791 A1
(43) Pub. Date: Nov. 3, 2005

(54) Channel estimation apparatus and method for OFDM/OFDMA receiver

(75) Inventors: Min-Cheol Park, Suwon-si (KR); Yun-Sang Park, Suwon-si (KR); Bong-Gee Song, Seongnam-si (KR); Jae-Hwan Chang, Suwon-si (KR)

Correspondence Address: DILWORTH & BARRESE, LLP, 333 EARLE OVINGTON BLVD., UNIONDALE, NY, 11553, US

(73) Assignee: SAMSUNG ELECTRONICS CO., LTD., GYEONGGI-DO (KR)

(21) Appl. No.: 10/971,491

(22) Filed: Oct. 22, 2004

(30) Foreign Application Priority Data
Apr. 30, 2004 (KR) 2004-30567

(51) Int. Cl. H04J 1/00

(52) U.S. Cl. 370/343

(57) ABSTRACT

A channel estimation apparatus and method for an OFDM/OFDAM receiver. A channel characteristic value, positioned prior to a pilot symbol of a current slot, from among data symbols of the current slot is estimated by a time-domain interpolation method for use with a channel characteristic value of a pilot symbol of a previous slot and a channel characteristic value of the pilot symbol of the current slot. A channel characteristic value next to the pilot symbol of the current slot from among the data symbols of the current slot is estimated by a time-domain extrapolation method for use with the channel characteristic value of the pilot symbol of the previous slot and the channel characteristic value of the pilot symbol of the current slot.

### PRIORITY

This application claims priority to an application entitled “CHANNEL ESTIMATION METHOD FOR OFDM/OFDMA RECEIVER AND CHANNEL ESTIMATOR FOR THE SAME”, filed in the Korean Intellectual Property Office on Apr. 30, 2004 and assigned Ser. No. 2004-30567, the contents of which are hereby incorporated by reference.

### BACKGROUND OF THE INVENTION

1. Field of the Invention

The present invention relates generally to an OFDM/OFDMA (Orthogonal Frequency Division Multiplexing/Orthogonal Frequency Division Multiple Access) transmission system, and more particularly to a method and apparatus for performing channel estimation using a pilot symbol in an OFDM/OFDMA receiver, such that channel distortion in the OFDM/OFDMA receiver can be compensated.

2. Description of the Related Art

An OFDM scheme or an OFDMA scheme based on the OFDM scheme is a multi-carrier modulation scheme for the parallel-transmission of data using several sub-carriers having orthogonality therebetween, instead of using a broadband single carrier. The OFDM or the OFDMA scheme is based on the fact that individual narrowband sub-channels have flat fading characteristics even in a frequency selective fading channel with a very large ISI (Inter-Symbol Interference). The OFDM scheme determines its symbol in a frequency domain, such that an equalizer for the frequency domain is required to compensate for channel distortion associated with a received symbol. A transmission end of the OFDM transmission system transmits a data symbol and also transmits a pilot symbol used for channel estimation to equalize the data symbol.

Technologies for selecting a pilot signal, which effectively estimates an OFDM channel and maintains a high transfer rate, and also a variety of OFDM channel estimation methods have recently been proposed. For example, a method for acquiring a channel characteristic value by averaging samples of the pilot signal in a time domain, and a method for estimating channel characteristics in a frequency domain using a mean squared error of the pilot signal and applying the estimated result to a signal compensation process have recently been introduced.

FIG. 1 is a block diagram illustrating a conventional OFDM receiver. More specifically, FIG. 1 illustrates a receiver for recovering data from a baseband signal acquired from a received signal.

Referring to FIG. 1, a burst symbol extractor 100 extracts an OFDM symbol from the baseband signal acquired from the received signal using an RF processor (not shown). If a CP (Cyclic Prefix) inserted from a transmission end is deleted from a CP remover 102 and is then FFT (Fast Fourier Transform)-processed by an FFT unit 104, the symbol extracted by the burst symbol extractor 100 is transmitted to an equalizer 108. Upon receiving the FFT-processed data signal, the equalizer 108 compensates for channel distortion according to a channel characteristic value estimated by a channel estimator 106. The signal in which channel distortion is compensated is demodulated by a demodulator 110, is viterbi-decoded by a decoder 112, and the viterbi-decoded data is recovered by a determination result of a decision unit 114.

The channel estimation in the channel estimator 106 is performed using a pilot symbol.

An exemplary pilot symbol for use in the OFDM scheme is illustrated in FIG. 2. As can be seen from FIG. 2, pilot symbols are arranged among data symbols. Oblique-lined circles are pilot symbols and empty circles having no oblique-lines are data symbols. More specifically, FIG. 2 illustrates pilot distribution according to IEEE (Institute of Electrical and Electronics Engineers) 802.16(d) in regard to sub-carriers in a frequency domain and also symbols in a time domain.

For the distribution format of the data and pilot symbols in the time domain, data is composed in slot units rather than symbol units, as can be seen from FIG. 3. More specifically, FIG. 3 is an example of an OFDM transmission frame according to IEEE 802.16(d). A preamble and a data symbol are positioned at a header of the OFDM transmission frame, and a plurality of slots follow the preamble and the data symbol. The data symbol following the preamble is a data symbol for transmitting header information of a corresponding frame, such that it will hereinafter be called a header data symbol. Each slot includes three data symbols, and one pilot symbol is positioned in each slot. In other words, one slot includes two data symbols, one pilot symbol, and one data symbol, which are sequentially connected in the time domain.

When one slot is configured as illustrated in FIG. 3, channel estimation of data symbols positioned in a data symbol interval between two pilot symbols is performed by a linear interpolation scheme in a time domain, as in the following Equations (1)-(3), acquired from channel characteristic values at positions of two pilot symbols positioned at both sides of the data symbol interval. In this case, the channel estimation for decoding data by compensating for channel distortion of the data in slot units requires information of a current slot and information of previous and next slots.

$$\begin{matrix}{H}_{k , 1} = \frac{1}{2} ( {P}_{k - 1} + {P}_{k} ) & ( 1 ) \\ {H}_{k , 2} = \frac{1}{4} ( {P}_{k - 1} + 3 {P}_{k} ) & ( 2 ) \\ {H}_{k , 3} = \frac{1}{4} ( 3 {P}_{k} + {P}_{k + 1} ) & ( 3 )\end{matrix}$$

Referring to Equations (1)-(3), assuming that a current slot with information to be recovered is determined to be a k-th slot, H_{k,1} is a channel characteristic value estimated for a first data symbol of the current slot ‘k’, H_{k,2} is a channel characteristic value estimated for a second data symbol of the current slot ‘k’, and H_{k,3} is a channel characteristic value estimated for a third data symbol of the current slot ‘k’ (see FIG. 4 illustrating a channel estimation method using a linear interpolation method).

Referring to Equations (1)-(3) and FIG. 4, Pₖ₋₁ is a channel characteristic value of a pilot symbol of the previous slot ‘k−1’, Pₖ is a channel characteristic value of a pilot symbol of the current slot ‘k’, and Pₖ₊₁ is a channel characteristic value of a pilot symbol of the next slot ‘k+1’.

Referring to FIG. 4, provided that the channel characteristic value of a received signal varies as a curved line 200, a linear interpolation method is performed using weight factors associated with positions of individual data symbols, such that a plurality of channel characteristic values H_{k,1}, H_{k,2}, and H_{k,3} are estimated as shown in Equations (1)-(3). That is, the channel characteristic values H_{k,1}, H_{k,2}, and H_{k,3} are associated with a slope 202 from Pₖ₋₁ to Pₖ and the other slope 204 from Pₖ to Pₖ₊₁.

As can be seen from FIG. 4, it can be understood that the aforementioned Equations (1)-(3) are acquired from the following Equations (4)-(6).

$$\begin{matrix}\frac{( {H}_{k , 1} - {P}_{k - 1} )}{2} = \frac{( {P}_{k} - {H}_{k , 1} )}{2} & ( 4 ) \\ \frac{( {H}_{k , 2} - {P}_{k - 1} )}{3} = \frac{( {P}_{k} - {H}_{k , 2} )}{1} & ( 5 ) \\ \frac{( {H}_{k , 3} - {P}_{k} )}{1} = \frac{( {P}_{k + 1} - {H}_{k , 3} )}{3} & ( 6 )\end{matrix}$$

If channel estimation is carried out by using a first slot (i.e., Slot 1) in the OFDM frame of FIG. 3 as a current slot, a preamble is used as a pilot symbol of a previous slot.

The channel estimation for the first data symbol of the OFDM frame of FIG. 3, i.e., a header data symbol between the preamble and the Slot 1, is performed using Equation (7).

$${H}_{0 , 0} = \frac{1}{4} ( 3 {P}_{0} + {P}_{1} ) \qquad ( 7 )$$

Referring to Equation (7), H_{0.0} is a channel characteristic value estimated for the header data symbol, P₀ is a channel characteristic value of the preamble, and P₁ a channel characteristic value of the pilot symbol of the Slot 1.

Equation (7) is acquired from Equation (8) in the same manner as in Equations (1)-(3).

$$\frac{( {H}_{0 , 0} - {P}_{0} )}{1} = \frac{( {P}_{1} - {H}_{0 , 0} )}{3} \qquad ( 8 )$$

In order to recover any slot information using the aforementioned channel estimation method, a channel characteristic value of a current slot to be recovered, a channel characteristic value of a previous slot, and a channel characteristic value of the next slot must be used. Consequently, a buffer capable of temporarily storing channel characteristic values of pilot symbols of three slots including the current slot is required. Further, a delay is created during the channel estimation.

### SUMMARY OF THE INVENTION

Accordingly, the present invention has been designed in view of the above and other problems, and it is an object of the present invention to provide a channel estimation method and apparatus for reducing a size of a buffer required for channel estimation and reducing a delay.

In accordance with the present invention, the above and other objects can be accomplished by a channel estimation method for estimating a channel characteristic value, positioned prior to a pilot symbol of a current slot, from among data symbols of the current slot according to a time-domain interpolation method for use with a channel characteristic value of a pilot symbol of a previous slot and a channel characteristic value of the pilot symbol of the current slot; and estimating a channel characteristic value next to the pilot symbol of the current slot from among the data symbols of the current slot according to a time-domain extrapolation method for use with the channel characteristic value of the pilot symbol of the previous slot and the channel characteristic value of the pilot symbol of the current slot.

### BRIEF DESCRIPTION OF THE DRAWINGS

The above and other objects, features, and advantages of the present invention will be more clearly understood from the following detailed description taken in conjunction with the accompanying drawings, in which:

FIG. 1 is a block diagram illustrating a conventional OFDM receiver;

FIG. 2 depicts the distribution of OFDM pilot symbols;

FIG. 3 is an example of an OFDM transmission frame;

FIG. 4 is a graph illustrating a channel estimation method using a linear interpolation method;

FIG. 5 is a graph illustrating a channel estimation method in accordance with a preferred embodiment of the present invention;

FIG. 6 is a block diagram illustrating a channel estimator in accordance with an embodiment of the present invention;

FIG. 7 is a flow chart illustrating a channel estimation process in accordance with an embodiment of the present invention; and

FIGS. 8-9 each illustrate comparisons between a channel estimation performance based on a linear interpolation method and an inventive channel estimation performance.

### DETAILED DESCRIPTION OF THE PREFERRED EMBODIMENTS

Preferred embodiments of the present invention will be described in detail herein below with reference to the annexed drawings. In the following description, a detailed description of known functions and configurations incorporated herein will be omitted when it may obscure the subject matter of the present invention.

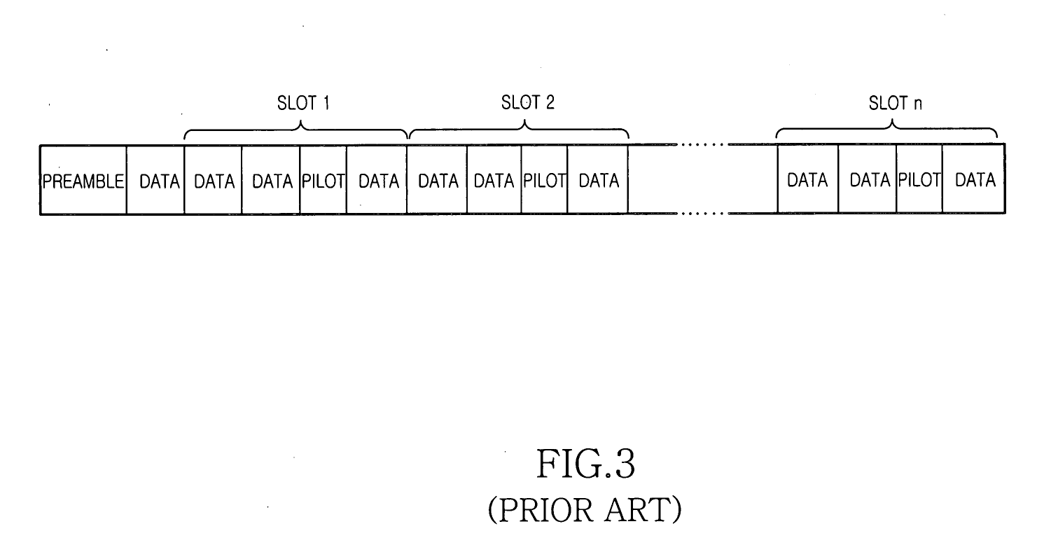

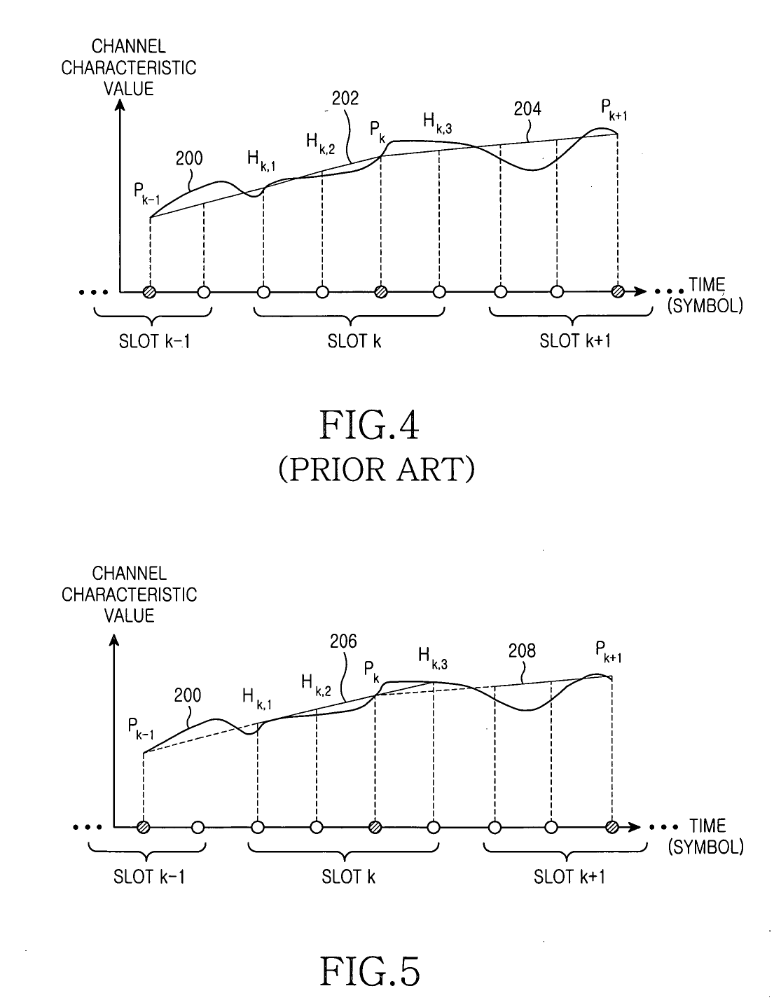

FIG. 5 is a graph illustrating a channel estimation method in accordance with a preferred embodiment of the present invention. Particularly, FIG. 5 shows an application example of the present invention when a single slot includes two data symbols, one pilot symbol, and one data symbol, which are connected in a time domain as illustrated in FIG. 3. FIG. 5 does not refer to a channel characteristic value Pₖ₊₁ of a pilot symbol of the next slot ‘k+1’, but refers to both a channel characteristic value Pₖ₋₁ of a pilot symbol of a previous slot ‘k−1’ and a channel characteristic value Pₖ of a pilot symbol of a current slot ‘k’, differently from FIG. 4, such that channel characteristic values H_{k,1}, H_{k,2}, and H_{k,3} can be estimated using the following Equations (9)-(11):

$$\begin{matrix}{H}_{k , 1} = \frac{1}{2} ( {P}_{k - 1} + {P}_{k} ) & ( 9 ) \\ {H}_{k , 2} = \frac{1}{4} ( {P}_{k - 1} + 3 {P}_{k} ) & ( 10 ) \\ {H}_{k , 3} = \frac{1}{4} ( - {P}_{k - 1} + 5 {P}_{k} ) & ( 11 )\end{matrix}$$

Although Equations (9)-(10) are equal to Equations (1)-(2), respectively, Equation (11) is different from Equation (3). Therefore, it can be understood that H_{k,3} is estimated differently from Equation (3) whereas H_{k,1}, and H_{k,2} are estimated using the interpolation method in the same manner as in Equations (1)-(2).

More specifically, the method of FIG. 5 does not perform channel estimation using an interpolation method, which refers to channel characteristic values of pilot symbols positioned at both sides of a data symbol next to the pilot symbol in each slot, but performs channel estimation using an extrapolation method in a time domain. In this case, the extrapolation method refers to both the channel characteristic value Pₖ₋₁ of the pilot symbol of the previous slot ‘k−1’ and the channel characteristic value Pₖ of the pilot symbol of the current slot ‘k’. Different from FIG. 4, it can be understood that the channel characteristic values H_{k,1}, H_{k,2}, and H_{k,3} of FIG. 5 are associated with a slope 206 from Pₖ₋₁ to H_{k,3}, and are not associated with a slope 208 from Pₖ to Pₖ₊₁. Therefore, a specific interval, which is not applied to channel estimation, is selected from a straight line of the slopes 206 and 208, and the selected interval is denoted by dotted lines, differently from FIG. 4.

As can be seen from FIG. 5, it can be noted that Equation (11) is acquired from the following Equation (12):

$$\frac{( {H}_{k , 3} - {P}_{k - 1} )}{5} = \frac{( {H}_{k , 3} - {P}_{k} )}{1} \qquad ( 12 )$$

A data symbol not included in slots, i.e., a first data symbol (also called a header data symbol) of the frame of FIG. 3, is channel-estimated in the same manner as in Equation (7).

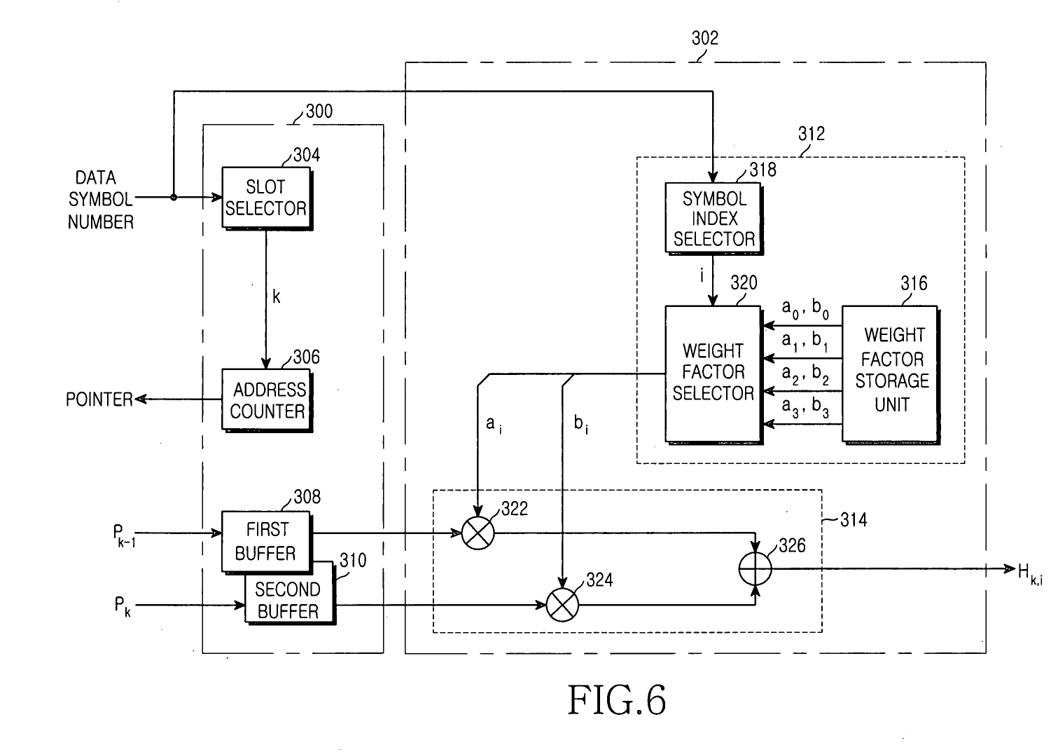

FIG. 6 is a block diagram illustrating a channel estimator in accordance with a preferred embodiment of the present invention. An application example of the present invention is depicted in FIG. 6 on the condition that one slot includes two data symbols, one pilot symbol, and one data symbol, which are sequentially connected in a time domain as illustrated in FIG. 3.

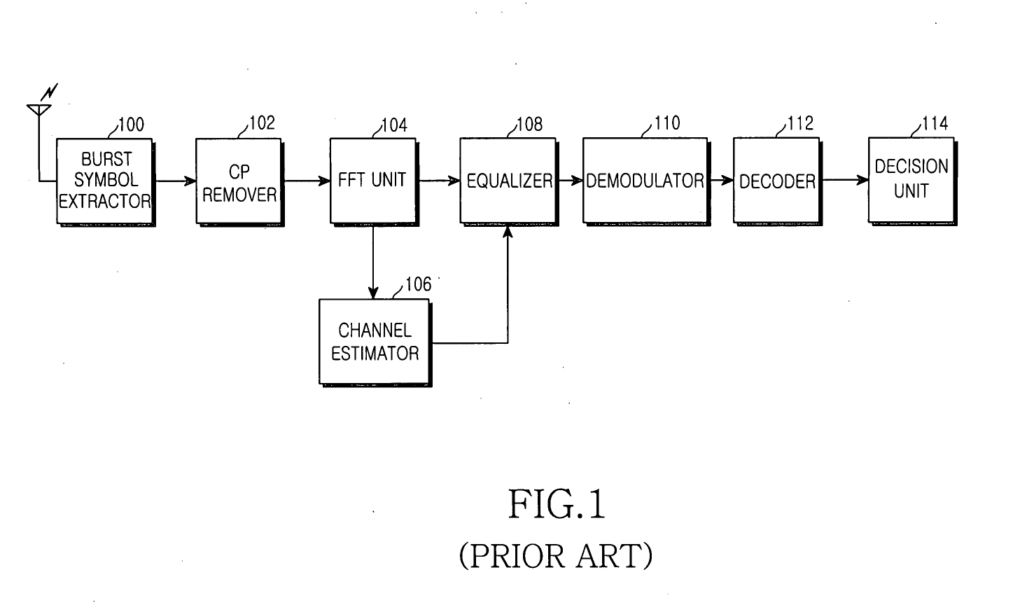

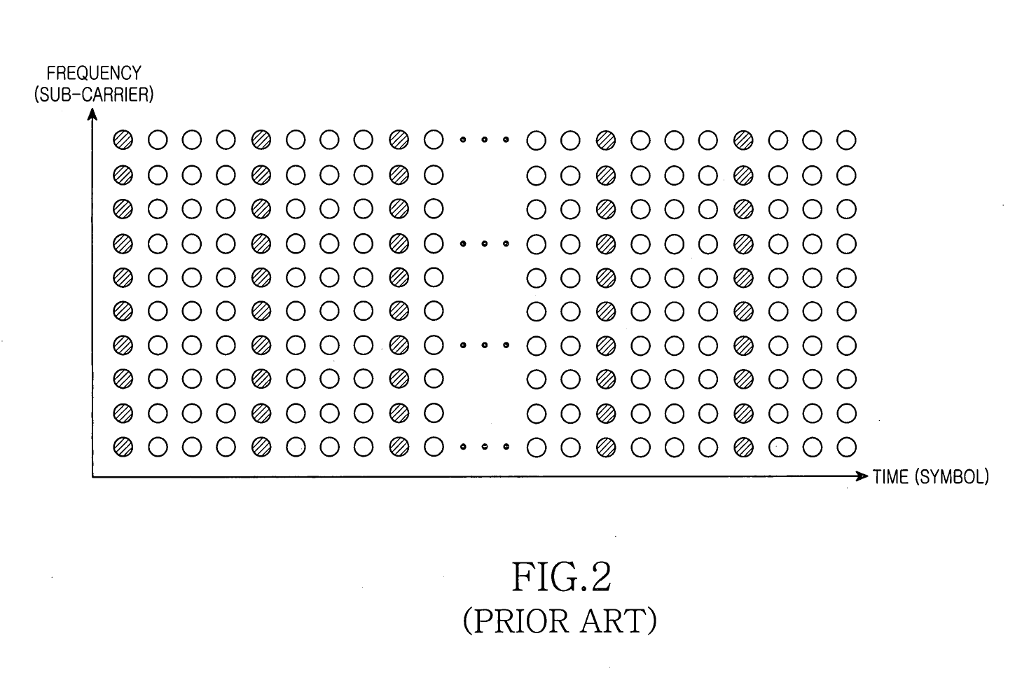

Referring to FIG. 6, the channel estimator includes a pilot reader 300 and a channel estimation processor 302. The pilot reader 300 includes a slot selector 304, an address counter 306, and first and second buffers 308 and 310, such that it checks a current slot number ‘k’ based on a data symbol number to be channel-estimated, and reads the channel characteristic value Pₖ₋₁ of the pilot symbol of the previous slot and the other channel characteristic value Pₖ of the pilot symbol of the current slot from the FFT (Fast Fourier Transform) unit 104 illustrated in FIG. 1. The data symbol number indicates consecutive numbers ranging from a data symbol next to the preamble to the last data symbol (i.e., the last data symbol of the last slot ‘n’), in association with data symbols contained in one frame (see FIG. 3) in a typical OFDM receiver. Therefore, the data symbol number applied to the slot selector 304 of the pilot reader 300 indicates the order of a data symbol, which must be currently channel-estimated, from among data symbols contained in one frame.

The slot selector 304 determines a current slot number ‘k’ on the basis of a data symbol number in order to select a slot including the data symbol to be currently channel-estimated, and applies the determined current slot number to the address counter 306. The slot selector 304 determines a slot number ‘k’ to be ‘0’ in association with the header data symbol next to the preamble in one frame. In association with the following data symbols next to the header data symbol, the slot selector 304 increases the slot number ‘k’ by one for every three data symbols, because three data symbols exist in each slot.

The address counter 306 transmits a pointer, which increases as the slot number ‘k’ received from the slot selector 304 increases, to the FFT unit 104 illustrated FIG. 1. Additionally, the address counter 306 selects the channel characteristic value Pₖ₋₁ of the pilot symbol of the previous slot ‘k−1’ and the other channel characteristic value Pₖ of the pilot symbol of the current slot ‘k’, and reads the channel characteristic values Pₖ₋₁ and Pₖ. The pointer generated from the address counter 306 identifies an address of a storage area in which the channel characteristic value Pₖ₋₁ of the pilot symbol of the previous slot ‘k−1’ and the other channel characteristic value Pₖ of the pilot symbol of the current slot ‘k’ are stored. The channel characteristic value Pₖ₋₁ of the pilot symbol of the previous slot ‘k−1’ and the other channel characteristic value Pₖ of the pilot symbol of the current slot ‘k’ are temporarily stored in first and second buffers 308 and 310, respectively.

The channel estimation processor 302 includes a weight factor provider 312 and a channel characteristic value generator 314. The channel estimation processor 302 applies a weight factor to both the channel characteristic value Pₖ₋₁ of the pilot symbol of the previous slot ‘k−1’ and the other channel characteristic value Pₖ of the pilot symbol of the current slot ‘k’, such that channel estimation for a data symbol is performed by interpolation or extrapolation in a time domain using Equation (13). Consequently, the channel estimation value H_{k,i} created by channel estimation is transmitted to the equalizer 108 illustrated in FIG. 1.
H_{k,i}=aᵢ×Pₖ₋₁+bᵢ×Pₖ (13)

In Equation (13), i is an index of the order of data symbols contained in one slot, aᵢ is applied to the channel characteristic value Pₖ₋₁ of the pilot symbol of the previous slot according to positions of individual data symbols contained in one slot, bᵢ is applied to the channel characteristic value Pₖ of the pilot symbol of the current slot according to positions of individual data symbols contained in one slot, in which aᵢ and bᵢ are a pair of weight factors for every index i, and H_{k,i} is a channel characteristic value estimated for an i-th data symbol from among data symbols contained in one slot.

As described above, the present invention has been used in a case in which one slot includes two data symbols, one pilot symbol, and one data symbol connected in the time domain. However, provided that channel estimation is performed using a pilot symbol positioned between data symbols in a single slot even though the number of data symbols contained in the single slot or the location of the pilot symbol contained in the single slot is changed to another value, the present invention can also be used.

Equation (13) is obtained by generalizing Equations (9)-(11) in consideration of the above case in which the number of data symbols in the single slot or the location of the pilot symbol in the single slot is changed to another value. Therefore, the weight factors aᵢ and bᵢ are determined according to the index i.

In FIG. 3, the index i ranges from 0 to 3. If the index i is determined to be ‘0’, this identifies a channel estimation case associated with the header data symbol. If the index i is determined to be ‘1’, this identifies a channel estimation case associated with the first data symbol from among data symbols of each slot. If the index i is determined to be ‘2’, this identifies a channel estimation case associated with the second data symbol from among data symbols of each slot. If the index i is determined to be ‘3’, this identifies a channel estimation case associated with the third data symbol from among data symbols of each slot. Therefore, the weight factors aᵢ and bᵢ in association with the header data symbol used when i=0 are determined as illustrated in Table 1 using Equation (7). The weight factors aᵢ and bᵢ in association with data symbols in one slot are determined as shown in the following Table 1 using Equations (9)-(11).

TABLE 1

| Index i | aᵢ | bᵢ = 1 − aᵢ |
|---|---|---|
| 0 | ¾ | ¼ |
| 1 | ½ | ½ |
| 2 | ¼ | ¾ |
| 3 | −¼ | 5/4 |

If the number of data symbols in one slot or the location of the pilot symbol in one slot is different from that illustrated in FIG. 3, the range of i varies with the number of data symbols in one slot, such that not only the number of aᵢ and bᵢ indicating a pair of weight factors, but also values of the weight factors aᵢ and bᵢ must be differently determined according to the number of data symbols in one slot and the location of the pilot symbol in one slot.

The weight factors aᵢ and bᵢ, which comprise one pair for every index i, are generated from the weight factor provider 312. The weight factor provider 312 includes a weight factor storage unit 316, a symbol index selector 318, and a weight factor selector 320, such that it stores weight factor pairs aᵢ and bᵢ, and outputs a weight factor pair corresponding to the data symbol number to the channel characteristic value generator 314. In this case, FIG. 6 illustrates an example applied to the case illustrated in FIG. 3, such that weight factor pairs aᵢ and bᵢ stored in the weight factor storage unit 316 are denoted by a₀ and b₀, a₁ and b₁, a₂ and b₂, and a₃ and b₃, as described in Table 1.

The symbol index selector 318 determines the index i for selecting a weight factor on the basis of a data symbol number to be channel-estimated, and applies the determined index i to the weight factor selector 320. The symbol index selector 318 determines an index i of the header data symbol next to the preamble in one frame to be ‘0’, determines an index i of the first data symbol from among three data symbols contained in one slot to be ‘1’, determines an index i of the second data symbol to be ‘2’, and determines an index i of the third data symbol to be ‘3’. Accordingly, the symbol index selector 318 sequentially increases indexes i of the first to third data symbols one by one. The weight factor selector 320 selects a pair of weight factors aᵢ and bᵢ corresponding to the index i determined by the symbol index selector 318, and transmits the selected weight factors to the channel characteristic value generator 314.

The channel characteristic value generator 314 includes two multipliers 322 and 324, and a single adder 326. The first multiplier 322 multiplies a channel characteristic value Pₖ₋₁ of a pilot symbol of the previous slot ‘k−1’ received from the first buffer 308 by the weight factor aᵢ. The second multiplier 324 multiplies a channel characteristic value Pₖ of a pilot symbol of the current slot ‘k’ received from the second buffer 310 by the weight factor bᵢ. The adder 326 adds the output values of the first and second multipliers 322 and 324, such that the channel characteristic value H_{k,i} of Equation (13) is generated and is then applied to the equalizer 108 illustrated in FIG. 1.

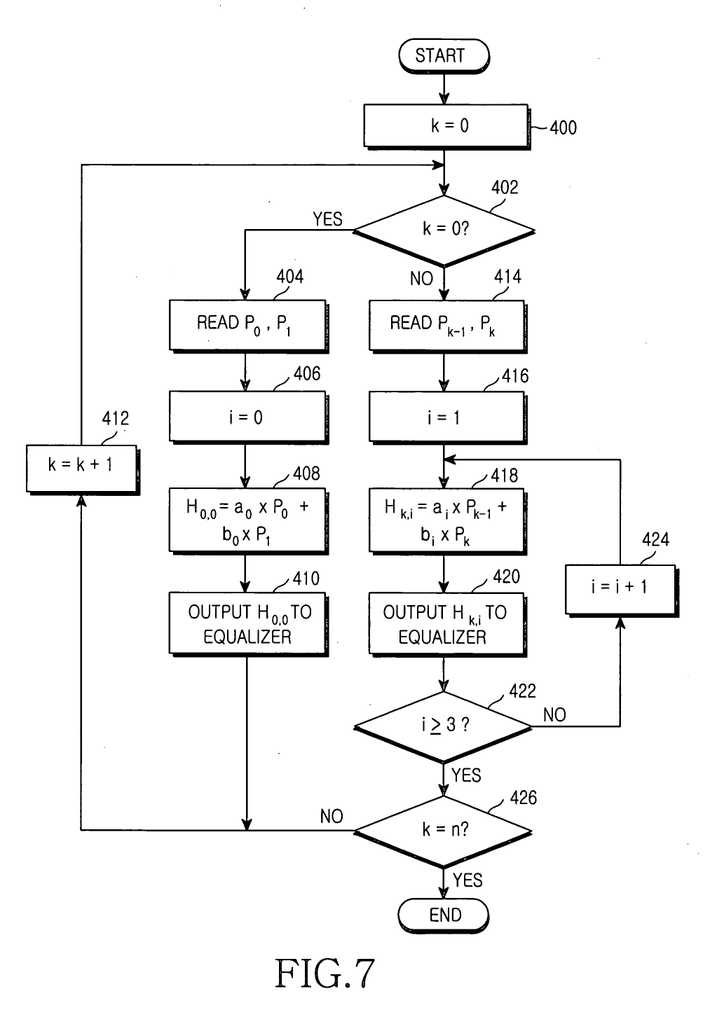

FIG. 7 is a flow chart illustrating a method for controlling the channel estimator illustrated in FIG. 6 to perform channel estimation associated with data symbols of a single frame. Referring to FIG. 7, the current slot ‘k’ is determined to be ‘0’ by the slot selector 304 at step 400. At step 402, it is determined if the current slot ‘k’ is ‘0’. If it is determined that the current slot ‘k’ is ‘0’ at step 402, steps 404 to 410 are performed. However, if it is determined that the current slot ‘k’ is not ‘0’ at step 402, then steps 414 to 422 are performed.

Steps 404 to 410 illustrate channel estimation processes associated with the header data symbol from among the data symbols contained in one frame illustrated in FIG. 3. Using the address counter 306, the channel characteristic value P₀ of the preamble and the channel characteristic value P1 of the pilot symbol of the Slot 1 are read as channel characteristic values Pₖ₋₁ and Pₖ, respectively, from the FFT unit 104 illustrated FIG. 1 to the first and second buffers 308 and 310 at step 404, such that the channel characteristic values Pₖ₋₁ and Pₖ are applied to the multipliers 322 and 324, respectively. The index i is determined to be ‘0’ by the symbol index selector 318 at step 406, such that the weight factors aᵢ and bᵢ are selected by the weight factor selector 320, and the selected weight factors aᵢ and bᵢ are applied to the multipliers 322 and 324, respectively. Therefore, the channel characteristic value generator 314 performs the operation of a specific case in which the index i is determined to be ‘0’ in Equation (13) at step 408, such that the channel characteristic value H_{0,0} associated with the header data symbol is calculated using Equation (7).

The channel characteristic value H_{0,0} is transmitted to the equalizer 108 illustrated in FIG. 1 at step 410. Accordingly, after the channel estimation associated with the header data symbol has been performed, the slot selector 304 increases a current slot number ‘k’ by one at step 412. Therefore, the current slot ‘k’ is not ‘0’ at step 402, and steps 414 to 422 are subsequently performed.

Steps 414 to 422 illustrate a channel estimation process in which three data symbols of one slot in the frame illustrated in FIG. 3 are sequentially channel-estimated. The channel characteristic value Pₖ₋₁ of the pilot symbol of the previous slot ‘k−1’ and the channel characteristic value Pₖ of the pilot symbol of the current slot ‘k’ are read from the FFT unit 104 illustrated in FIG. 1 to the first and second buffers 308 and 310 at step 414, such that the channel characteristic values Pₖ₋₁ and Pₖ are applied to the multipliers 322 and 324, respectively. The index i is determined to be ‘1’ by the symbol index selector 318 at step 416, such that the weight factors aᵢ and bᵢ are selected by the weight factor selector 320, and the selected weight factors aᵢ and bᵢ are applied to the multipliers 322 and 324, respectively. Therefore, the channel characteristic value generator 314 performs the operation of Equation (13) at step 418, such that the channel characteristic value H_{k,i} associated with a specific data symbol (whose index i is ‘1’) from among data symbols of the current slot ‘k’, i.e., H_{k,1} of Equation (9), is calculated. The channel characteristic value H_{k,1} is applied to the equalizer 108 of FIG. 1 at step 420.

If the index i is equal to ‘3’ at step 422, after the channel estimation associated with one data symbol has been performed, step 426 is performed. However, if the index i is not equal to ‘3’ at step 422, step 424 is performed. If the index i is not equal to ‘3’ at step 422, i.e., if channel estimation for data symbols contained in one slot is not finished, the symbol index selector 318 increases the index i by ‘1’ at step 424, and steps 418 and 420 are repeated, such that channel estimation for the next data symbol can be performed. Therefore, the channel characteristic value H_{k,i} associated with data symbols (whose indexes i=2 and 3) from among data symbols of the current slot ‘k’, and the channel characteristic values H_{k,2} and H_{k,3} of Equations (10) and (11) are sequentially calculated, and the calculated channel characteristic values H_{k,2} and H_{k,3} are transmitted to the equalizer 108 illustrated in FIG. 1. If channel estimation of data symbols contained in one slot is terminated, the index i is determined to be ‘3’, so that steps 422 to 426 are performed.

At step 426, it is determined if a current slot number ‘k’ is equal to a maximum slot number ‘n’ in one frame of FIG. 3. If the current slot number ‘k’ is equal to the maximum slot number ‘n’ at step 426, an overall process is terminated. However, if the current slot number ‘k’ is not equal to the maximum slot number ‘n’ at step 426, the channel estimation is not finished yet, such that step 412 is performed.

At step 412, the slot selector 304 increases the current slot number ‘k’ by ‘1’. Therefore, when the current slot ‘k’ is not equal to ‘0’ at step 402, steps 414 to 422 are repeated. If channel estimation for one frame is finished by the repetition of the steps, the current slot number ‘k’ is equal to the maximum slot number ‘n’ at step 426 in such a way that the channel estimation for one frame can be performed.

Accordingly, the channel characteristic values H_{k,1}, H_{k,2}, and H_{k,3} associated with data symbols are estimated using only two channel characteristic values Pₖ₋₁ and Pₖ of two pilot symbols, instead of using the channel characteristic value Pₖ₊₁, such that only first and second buffers 308 and 310 are required to store the channel characteristic values Pₖ₋₁ and Pₖ of two pilot symbols, respectively, resulting in reductions of buffer size and delay.

As described above, the present invention estimates channel characteristic values using an interpolation or extrapolation for use with pilot symbols of only two slots, such that it minimizes performance deterioration caused by channel estimation, and at the same time reduces a buffer size consumed for channel estimation, and also delay.

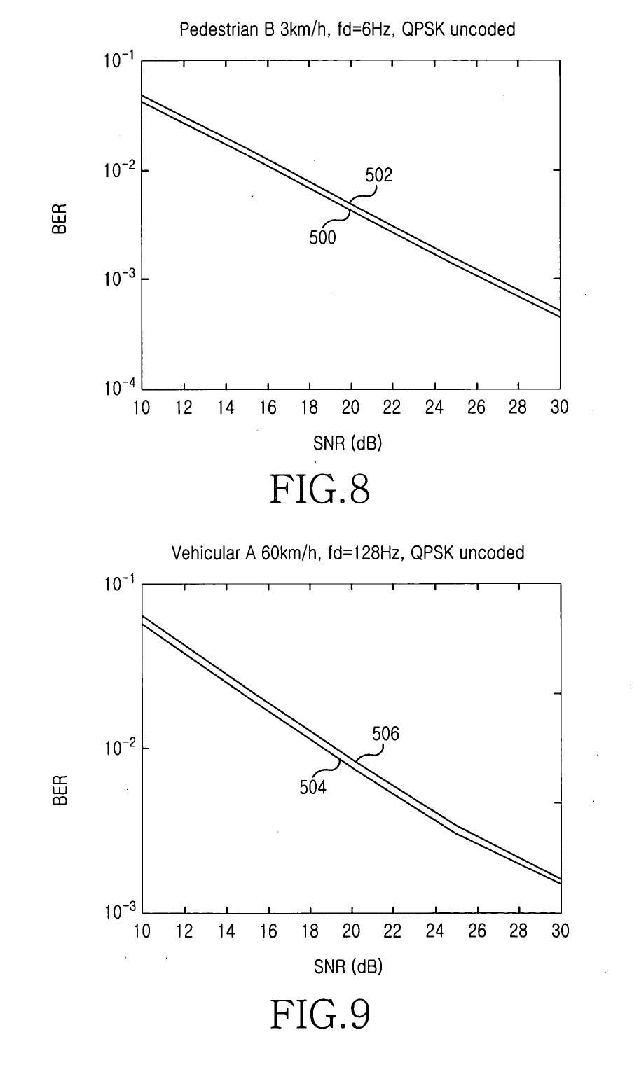

FIGS. 8-9 each illustrate results of comparisons between channel estimation performance based on a linear interpolation method described in Equations (1)-(3) and FIG. 4 and the channel estimation performance of the present invention. More specifically, FIG. 8 illustrates an exemplary graph of an SNR (Signal-to-Noise Ratio) to a BER (Bit Error Rate) at a specific speed of 3 km/h on the basis of an ITU (International Telecommunication Union) Pedestrian B model. In FIG. 8, the line denoted by reference number 500 indicates performance of channel estimation based on linear interpolation, and the line denoted by reference number 502 identifies performance of channel estimation of the present invention.

FIG. 9 illustrates an exemplary graph of an SNR to a BER at a specific speed of 60 km/h in an ITU (International Telecommunication Union) Vehicular A model. In FIG. 9, the line denoted by reference number 504 indicates performance of channel estimation based on the linear interpolation, and the line denoted by reference number 506 indicates performance of channel estimation of the present invention.

As can be seen from FIGS. 8 and 9, the difference between the channel estimation performance of the present invention and the other channel estimation performance based on the linear interpolation is only about 0.5 dB. Accordingly, the present invention reduces the buffer size and delay, and reduces deterioration of data restoration performance during the channel estimation.

Particularly, although the present invention has been described above with reference to a specific case in which one slot includes two data symbols, one pilot symbol, and one data symbol, which are sequentially connected in a time domain as illustrated in FIG. 3, based on IEEE 802.16(d), it should be noted that the present invention can be applied to an OFDM/OFDMA scheme and also other modulation schemes on the condition that the channel estimation is performed using pilot symbols positioned among data symbols within one slot. However, if the number of data symbols contained in a single slot or the location of a pilot symbol in the single slot is different from that illustrated in FIG. 3, the range of i varies with the number of data symbols included in the single slot, the number of weight factor pairs aᵢ and bᵢ, and individual values of the weight factor pairs aᵢ and bᵢ are also differently determined according to the number of data symbols included in the single slot and the location of the pilot symbol in the single slot.

Although preferred embodiments of the present invention have been disclosed for illustrative purposes, those skilled in the art will appreciate that various modifications, additions, and substitutions are possible, without departing from the scope and spirit of the present invention as disclosed in the accompanying claims.

1. A method for performing channel estimation using a pilot symbol positioned among data symbols of each slot in a time domain in a receiver for receiving an OFDM (Orthogonal Frequency Division Multiplexing) signal, comprising the steps of:
estimating a channel characteristic value associated with a data symbol, which is positioned prior to a pilot symbol of a current slot, from among data symbols of the current slot according to a time-domain interpolation method for use with a channel characteristic value of a pilot symbol of a previous slot and a channel characteristic value of a pilot symbol of the current slot; and
estimating a channel characteristic value associated with a data symbol, which is next to the pilot symbol of the current slot, from among the data symbols of the current slot according to a time-domain extrapolation method for use with the channel characteristic value of the pilot symbol of the previous slot and the channel characteristic value of the pilot symbol of the current slot.

2. The method according to claim 1, wherein the channel characteristic value of the data symbol is calculated using:
H_{k,i}=aᵢ×Pₖ₋₁+bᵢ×Pₖ
where i is an index of an order number of data symbols contained in one slot, aᵢ is a weight factor, which is applied to the channel characteristic value of the pilot symbol of the previous slot according to positions of individual data symbols contained in one slot, bᵢ is a weight factor, which is applied to the channel characteristic value of the pilot symbol of the current slot according to positions of individual data symbols contained in one slot, Pₖ₋₁ is a channel characteristic value of the pilot symbol of the previous slot, Pₖ is a channel characteristic value of the pilot symbol of the current slot, and H_{k,i} is a channel characteristic value estimated for an i-th data symbol from among the data symbols included in a slot.

3. The method according to claim 2, wherein the weight factor aᵢ is determined to be hd 1=½, a₂=¼, a₃=−¼, and the other weight factor bᵢ is determined to be 1−aᵢ, when the slot includes two data symbols, one pilot symbol, and one data symbol, which are sequentially connected in the time domain.

4. A channel estimator for performing channel estimation using a pilot symbol positioned among data symbols of each slot in a time domain in a receiver for receiving an OFDM (Orthogonal Frequency Division Multiplexing) signal, comprising:
a pilot reader for recognizing a current slot number using a data symbol number that identifies an order number of a data symbol to be channel-estimated from among data symbols contained in a single frame, and reading a channel characteristic value of a pilot symbol of a previous slot and a channel characteristic value of a pilot symbol of a current slot from an FFT (Fast Fourier Transform) unit on the basis of the recognized current slot number; and
a channel estimation processor for estimating a channel characteristic value associated with a data symbol, which is positioned prior to the pilot symbol of the current slot, from among data symbols of the current slot according to a time-domain interpolation method for use with the channel characteristic value of the pilot symbol of the previous slot and the channel characteristic value of the pilot symbol of the current slot, and estimating a channel characteristic value associated with a data symbol, which is next to the pilot symbol of the current slot, from among the data symbols of the current slot according to a time-domain extrapolation method for use with the channel characteristic value of the pilot symbol of the previous slot and the channel characteristic value of the pilot symbol of the current slot.

5. The channel estimator according to claim 4, wherein the channel estimation processor comprises:
a weight factor provider for storing weight factor pairs, each of which is includes first and second weight factors, which are respectively applied to the channel characteristic value of the pilot symbol of the previous slot and the channel characteristic value of the pilot symbol of the current slot according to locations of individual data symbols in one slot, and generating a pair of the first and second weight factors corresponding to the data symbol number; and
a channel characteristic value generator for performing one of an interpolation method and an extrapolation method according to
H_{k,i}=aᵢ×Pₖ₋₁+bᵢ×Pₖ
upon receiving the channel characteristic value of the pilot symbol of the previous slot, the channel characteristic value of the pilot symbol of the current slot, and the first and second weight factors, and generating a channel characteristic value associated with the data symbol,
where i is an index of an order number of data symbols contained in one slot, aᵢ is indicative of a first weight factor, bᵢ is a second weight factor, Pₖ₋₁ is the channel characteristic value of the pilot symbol of the previous slot, Pₖ is the channel characteristic value of the pilot symbol of the current slot, and H_{k,i} is a channel characteristic value estimated for an i-th data symbol from among data symbols included in a slot.

6. The channel estimator according to claim 5, wherein the first weight factor aᵢ is determined to be a₁=½, a₂=¼, a₃=−¼, and the second weight factor bᵢ is determined to be 1−aᵢ, when the slot includes two data symbols, one pilot symbol, and one data symbol, which are sequentially connected in the time domain.
